(19) United States
(12) Patent Application Publication
(10) Pub. No.: US 2024/0253946 A1
(43) Pub. Date: Aug. 1, 2024

(54) ELEVATOR SYSTEM AND METHOD OF AUTHENTICATING A COMPUTING DEVICE TO A SAFETY CONTROLLER OF AN ELEVATOR SYSTEM

(71) Applicant: Otis Elevator Company, Farmington, CT (US)

(72) Inventors: Niko Julian-Hall, Leegebruch (DE); Peter Herkel, Berlin (DE)

(21) Appl. No.: 18/513,049

(22) Filed: Nov. 17, 2023

(30) Foreign Application Priority Data
Jan. 30, 2023 (EP) 23154065.9

(51) Int. Cl. B66B 5/00

(52) U.S. Cl. CPC B66B 5/0031; B66B 5/0025

(57) ABSTRACT

An elevator system includes a gateway device and a safety controller arranged to monitor at least one safety condition of the elevator system. The gateway device is configured to enable a computing device to establish a connection with the gateway device. The safety controller is configured to: receive first authentication information from the gateway device, wherein the first authentication information is gateway authentication information; check whether the gateway authentication information meets a first authentication condition; if the gateway authentication information meets the first authentication condition, receive from the computing device, via the gateway device, second authentication information; check whether the second authentication information meets a second authentication condition; and if the second authentication information meets the second authentication condition, authenticate the computing device, wherein the authenticated computing device is granted maintenance access to the safety controller including permission to control and/or modify an operation of the safety controller.

### FOREIGN PRIORITY

This application claims priority to European Patent Application No. 23154065.9, filed Jan. 30, 2023, and all the benefits accruing therefrom under 35 U.S.C. § 119, the contents of which in its entirety are herein incorporated by reference.

### TECHNICAL FIELD

This disclosure relates to an elevator system and a method of authenticating a computing device to a safety controller of an elevator system.

### BACKGROUND

It is known to provide a safety controller to monitor at least one safety condition of an elevator system. For example, the safety controller may monitor the status of a plurality of safety contacts that are connected to the safety controller. The plurality of safety contacts may be connected in series to form a safety chain. Each switch, or safety contact, in the safety chain typically corresponds to a separate component of the elevator system, e.g. door sensors detecting whether a door lock has engaged. The safety chain is configured such that the activation of a single safety contact, e.g. the opening of a single switch in the safety chain, due to a failure of any one of the sensed components, prevents operation of the elevator system.

A maintenance person may be able to access the safety controller, either locally or remotely, in order to obtain data or make modifications to safety functions of the safety controller. It is desirable that a maintenance person is authenticated before some (or possibly all) interactions with the safety controller are enabled, in order to ensure the security of the safety controller, and therefore that safe operation of the elevator system is not compromised.

### SUMMARY

According to a first aspect of this disclosure there is provided an elevator system comprising: a gateway device; a safety controller arranged to monitor at least one safety condition of the elevator system, wherein the gateway device is configured to enable a computing device to establish a connection with the gateway device, and wherein the safety controller is configured to: receive first authentication information from the gateway device, wherein the first authentication information is gateway authentication information; check whether the gateway authentication information meets a first authentication condition; if the gateway authentication information meets the first authentication condition, receive from the computing device, via the gateway device, second authentication information; check whether the second authentication information meets a second authentication condition; and if the second authentication information meets the second authentication condition, authenticate the computing device, wherein the authenticated computing device is granted maintenance access to the safety controller including permission to control and/or modify an operation of the safety controller.

According to a second aspect of this disclosure there is provided a method of authenticating a computing device to a safety controller of an elevator system for maintenance access to the safety controller, the method comprising: the computing device establishing a connection with a gateway device of an elevator system; the safety controller: receiving from the gateway device first authentication information, wherein the first authentication information is gateway authentication information; checking whether the gateway authentication information meets a first authentication condition; if the gateway authentication information meets the first authentication condition, receiving from the computing device, via the gateway device, second authentication information; checking whether the second authentication information meets a second authentication condition; and if the second authentication information meets the second authentication condition, authenticating the computing device, wherein the authenticated computing device is granted maintenance access to the safety controller including permission to control and/or modify an operation of the safety controller.

By authenticating a computing device to a safety controller, using a two-stage authentication process which requires two separate pieces of authentication information, it is possible to realize a more secure connection by which authorized personnel only are able to access the safety controller in a manner which permits them to control or modify an operation of the safety controller. Carrying out this two-stage process using a gateway device of an elevator system improves both convenience and security. In particular, there is no need for the computing device to establish a direct communication link with the safety controller, since the authentication is carried out via the gateway device.

It is stated that the safety controller receives second authentication information from the computing device, via the gateway device, if the gateway authentication information meets the first authentication condition. By this it will be understood that the safety controller does not receive the second authentication information if the gateway authentication information does not meet the first authentication condition (e.g., by the safety controller being arranged to only request second authentication information after the first authentication information has been successfully checked). This prevents the second authentication information from being transmitted by the computing device unnecessarily if the authentication of the gateway device has already failed.

Similarly, it will be understood that the computing device is authenticated only if the second authentication information meets the second authentication condition, and therefore necessarily if the first authentication information meets the first authentication condition, since this must be the case in order for the second authentication information to have been transmitted to the safety controller for checking.

In some examples, the computing device establishing a connection with the gateway device comprises the computing device providing second authentication information (e.g., computing device authentication information) to the gateway device, the gateway device checking whether the second authentication information meets a computing-device authentication condition; and if the second authentication information meets the computing-device authentication condition, the gateway device establishing a connection with the computing device. Thus, the computing device establishing a connection with the gateway device may comprise the computing device authenticating itself to the gateway device (i.e., authentication may be required in order for the gateway device to communicate with the computing device). The computing-device authentication condition may be the same as, or different to, the second authentication condition referred to above.

In some examples, the first authentication information (i.e., the gateway authentication information) and/or the second authentication information is asymmetrically encrypted (i.e. encryption which uses a public key together with a corresponding private key). This is a reliable and safe authentication method. For example, the gateway device may be configured to asymmetrically encrypt a first set of credentials to provide the first authentication information. The gateway device may be configured to encrypt the first set of credentials with a first public key. The computing device may be configured to encrypt a (second) set of credentials (e.g., a different set of credentials) with a (second) public key to provide the second authentication information.

Alternatively, the information may be encrypted using a first private key, and decrypted using a first public key. This is known as adding a digital signature. Thus, in some examples, the gateway device is configured to encrypt the first set of credentials with a first private key (i.e., the gateway device is configured to digitally sign the first authentication information). In some examples, the computing device is configured to encrypt a (second) set of credentials (e.g., a different set of credentials) with a (second) private key to provide the second authentication information (i.e., the computing device is configured to digitally sign the second authentication information).

In some examples, the safety controller is configured to decrypt (and optionally verify) the encrypted first authentication information using the first private key. The safety controller may store the first private key. Alternatively, in other examples, the safety controller is configured to decrypt (and optionally verify) the encrypted first authentication information using the first public key. The safety controller may store the first public key, and/or it may receive the first public key from the gateway device (e.g., as part of the first authentication information). It will be understood that the first private key corresponds to the first public key, in the manner known in the field of asymmetric encryption. Thus, the (first) authentication condition (for authenticating the gateway device to the safety controller) may be the successful decryption of the encrypted first authentication information using the first private or public key.

In some examples, additionally or alternatively to asymmetric encryption, the first authentication information and/or the second authentication information is symmetrically encrypted (i.e. encryption which uses a single cryptographic key, known to both parties, for both encryption and decryption). In the case of symmetric key authentication, the key may be generated during an initial authentication round and be stored only for a particular communication session.

In some examples, the safety controller is configured to decrypt (and optionally verify) the encrypted second authentication information using the second private key. The safety controller may store the second private key. Alternatively, in other examples, the safety controller stores a second public key, and is configured to decrypt (and optionally verify) the encrypted second authentication information using the second public key. The safety controller may store the second public key, and/or it may receive the second public key from the computing device (e.g., as part of the second authentication information). It will be understood that the second private key corresponds to the second public key, in the manner known in the field of asymmetric encryption. Thus, the (second) authentication condition, by which the computing device is authenticated by the safety controller, may be the successful decryption of the encrypted second authentication information using the second private or public key.

In some examples, the first authentication information and/or the second authentication information may be generated by a (trusted) certificate authority. The gateway device may be arranged to send a first request containing the first public key, and the first set of credentials, to the certificate authority. The certificate authority may verify the information in the request and generate the first authentication information by encrypting the first request with a certificate authority private key. This first authentication information (and optionally the certificate authority public key, corresponding to the certificate authority private key used to encrypt the first request) may then be sent to the gateway device, and stored on the gateway device.

Similarly, the computing device may be arranged to send a second request containing the second public key and the second set of credentials to the certificate authority. The certificate authority may verify the information in the request and generate the second authentication information by encrypting the second request with a certificate authority private key. This second authentication information (and optionally the certificate authority public key, corresponding to the certificate authority private key used to encrypt the second request) may then be sent to the computing device, and stored on the computing device.

The safety controller may be arranged to confirm that the certificate authority has verified the first authentication information and/or the second authentication information by decrypting the information using a certificate authority public key (i.e. a key corresponding to the certificate authority's private key). Thus, in some examples, the method further comprises the gateway device encrypting a first set of credentials to provide the first authentication information using a (first) public key or a (first) private key. In some examples, the method further comprises the safety controller decrypting the first authentication information using a (first) private key or a (first) public key, stored on the safety controller. Similarly, in some examples, the method further comprises the computing device encrypting a second set of credentials to provide the second authentication information using a second public key or a second private key. In some examples, the method further comprises the safety controller decrypting the second authentication information using a second private key or a second public key, stored on the safety controller.

Although it is described above that the first authentication information and second authentication information are generated and/or verified by the same certificate authority, alternatively, each could be associated with a different certificate authority, i.e., different certificate authorities could be used to generate each set of authentication information.

The gateway authentication information will be understood to be authentication information (e.g., a certificate) which is uniquely associated with the particular gateway device. The gateway authentication information may be stored on the gateway device. Thus, in some examples the gateway device comprises a memory, wherein the gateway device is arranged to store the gateway authentication information in the memory.

The elevator system may comprise more than one safety controller (i.e., the elevator system may be one comprising more than one group of elevators, where each group has its own safety controller). The gateway device may be connected to each of the more than one safety controllers in the elevator system. Thus, there may be one gateway device providing gateway services for several safety controllers.

In some examples, the elevator system further comprises an elevator controller, configured to control operation of the elevator car. The safety controller may be part of the elevator controller, or they may be separate. The gateway device may be connected to the elevator controller (e.g., over a wired or wireless communications network).

The elevator system may comprise more than one elevator controller. The gateway device may be connected to each of the more than one elevator controllers in the elevator system. Thus, there may be one gateway device providing gateway services for several elevator controllers.

The second authentication information may be computing device authentication information (i.e., associated uniquely with a particular computing device, for example by means of a certificate, as described above, stored on the computing device). The second authentication information may be stored on the computing device. Thus, in some examples the computing device comprises a memory, wherein the computing device is arranged to store the computing device authentication information in the memory. Alternatively, the second authentication information may be maintenance person authentication information (i.e., associated uniquely with a particular maintenance person).

In some examples, the elevator system further comprises the computing device.

The computing device may be a remote computing device. It will be understood that such a remote computing device is one which is located remotely relative to the elevator system, i.e. as opposed to being located locally at the elevator system. Such a remote computing device therefore does not require, and preferably does not have, a physical connection to the elevator system, but rather can be located far from the elevator system, e.g. could be located in a service centre far away.

The computing device may be a mobile telephone or mobile service tool (e.g., a maintenance service tool, such as the kind carried by a maintenance person). The computing device may be arranged to be operated by a maintenance person in order to carry out the described authentication process, and/or to carry out the control and/or modification of an operation of the safety controller.

Alternatively, the computing device may be a server or computer. The computing device may be arranged to carry out some or all of the authentication process in an automated manner and/or to carry out the control and/or modification of an operation of the safety controller in an automated manner (e.g., by being pre-programmed to carry out certain defined actions in defined circumstances).

The safety controller is configured to connect to the computing device via the gateway device. The gateway device is a computer device, separate from the safety controller, but connected to it and connected to the elevator controller. The gateway device may be locally connected to the safety controller (e.g., via a wired connection). The gateway device may be connected to the safety controller via e.g., a CAN bus, Ethernet, or any other Field bus (wired or wireless).

The gateway device may be connected to the Cloud and/or the Internet. It may therefore connect to various devices (e.g., including the safety controller, and the communication device) via the Internet. It also allows the devices to which it is connected to themselves connect to the Internet or the Cloud, via the gateway device. For example, data from the elevator system may be sent to the gateway device, from where it is then uploaded to storage in the Cloud, or transmitted over the Internet to a server. The gateway device may be connected to an external server device (e.g., a server operated by an elevator company), e.g., via the Internet. The connection between the gateway device and the external server device may be an authenticated connection. Data transmitted via the authenticated connection may be encrypted. The gateway device translates internal communication protocols within the elevator system to a standard protocol used for Internet/cloud communication. This allows devices within the elevator system (e.g., controller, safety system) to use the internal communication protocols, rather than each device or component within the elevator system needing to be capable of the Internet/cloud communication protocol in addition to the internal communication protocol.

The gateway device may also act as a firewall to only allow specific, previously defined connections into the elevator system (e.g., a whitelist approach). It may also permit only limited access to specific data present in the elevator system. Thus, the gateway device adds a cybersecurity protection layer to the safety system, so that a hacker is not able to directly access the safety system.

The safety controller may be connected to the gateway device over a (wired or wireless) communications network. In some examples, additionally or alternatively, the gateway device may be connected to the computing device over a (wired or wireless) communications network. The gateway device may be connected to the safety controller over a first communications network and may be connected to the computing device over a second, separate communications network. In some examples the first communications network and/or the second communications network comprises a wireless network, preferably a long-range wireless network such as a cloud-based network (e.g. the Internet). In some examples, the method further comprises the computing device and/or the safety controller, and/or the gateway device connecting to a (wireless) communications network. The method may further comprise the gateway device sending the first authentication information to the safety controller over a (first) (wireless) communications network. The method may further comprise the computing device sending the second authentication information to the gateway device over a (second) (wireless) communications network. The method may further comprise the gateway device sending the second authentication information to the safety controller over a (first) (wireless) communications network.

In some examples, the gateway device is arranged to receive a maintenance access request from the computing device, and, in response, to issue a maintenance access request to the safety controller, on behalf of the computing device. Thus, in some examples, the method comprises the computing device issuing to the gateway device a maintenance access request. In some examples, the method comprises, in response to receiving the maintenance access request from the computing device, the gateway device issuing the maintenance access request to the safety controller, on behalf of the computing device.

In some examples, the safety controller is configured, in response to receiving the maintenance access request, to issue a first authentication information request to the gateway device, requesting that it provide first authentication information. Thus, the method may comprise the safety controller issuing a first authentication information request to the gateway device, in response to receiving the maintenance access request. The gateway device may be arranged to transmit first authentication information to the safety controller in response to receipt of the first authentication information request. Thus, the method may further comprise the gateway device transmitting first authentication information to the safety controller in response to receipt of the first authentication information request.

In some examples, the safety controller is arranged to issue a second authentication information request to the gateway device, if the gateway authentication information meets the first authentication condition. Thus, the method may further comprise if the gateway authentication information meets the first authentication condition, the computing device issuing to the gateway device a second authentication information request. The gateway device may be arranged to pass the second authentication information request to the computing device. Thus, the method may further comprise the gateway device passing the second authentication information request to the computing device.

The computing device may be arranged to send second authentication information to the safety controller, via the gateway device, in response to receipt of the second authentication information request. Thus, the method may comprise the computing device sending second authentication information to the safety controller, via the gateway device, in response to receipt of the second authentication information request. It will be understood that sending information via the gateway device means that the computing device transmits the information to the gateway device and the gateway device then transmits this information to the safety controller. Thus, the computing device does not need to establish a direct communication link with the safety controller.

The elevator system may further comprise a plurality of safety contacts.

The plurality of safety contacts may monitor the elevator system. The safety controller may be connected to the plurality of safety contacts (e.g., over a bus). The safety controller may be configured to receive individual status information from each of the plurality of safety contacts and to prevent movement of the elevator car when the individual status information received from one of the plurality of safety contacts indicates an unsafe condition of the elevator system.

In some examples, the safety controller is part of a safety system. The safety system may also comprise bus nodes, which are connected to a bus, wherein the bus is connected to the safety controller, and the bus nodes are connected to the safety contacts. The bus may be a Controller Area Network (CAN) bus. However, any other suitable communication means may be employed to connect the safety controller to the safety contacts. The safety controller may include a microprocessor, which may run software. The microprocessor may poll the bus nodes, e.g. at regular intervals, to obtain the individual status information of the safety contacts.

Preferably the successful authentication itself does not automatically control or modify an operation of the safety controller (e.g., override the safety controller). Rather, in some examples, the safety controller is configured to receive a command from the computing device before controlling or modifying an operation of the safety controller. Thus, in some examples, the method further comprises the computing device sending an operation control command and/or an operation modification command to the safety controller.

In some examples, controlling and/or modifying an operation of the safety controller may include overriding the safety controller (e.g., overriding or modifying a safety function of the safety controller). Safety functions may include monitoring of a final limit switch. The override or modification may last for only a limited time period. It will be understood that overriding of the safety controller refers to overriding the automatic action of the safety controller which normally prevents movement of the elevator car (e.g. disconnection of the drive power supply) such that once again movement of the elevator car is permitted. In order to override the safety controller, the computing device acts in any suitable way to reverse the indication of an unsafe condition from one of the safety contacts. This may for example, involve an override command from the computing device to the safety controller. In at least some examples, the computing device can override the safety controller by bridging the safety contacts that indicated an unsafe condition, e.g. using software of the safety controller. Thus, in some examples, controlling and/or modifying an operation of the safety controller includes overriding an input of a node of the safety controller. Such an override is required in order to re-enable movement of the elevator car e.g. following an emergency stop due to the opening of a safety contact. It is particularly important that movement of the elevator car is re-enabled where passengers are trapped within the elevator car following an emergency stop.

In some examples, additionally or alternatively, controlling or modifying an operation of the safety controller may comprise issuing an action command to the elevator car via the safety controller to control operation of the elevator car to carry out an action in response to the action command, following authentication. Similarly, in some examples, the method further comprises the computing device sending an action command to the safety controller and the safety controller controlling operation of the elevator car to carry out an action in response to the action command, following authentication. An action command may be, for example, a command to move the elevator car up or down the hoistway, or a command to open the doors of the elevator car. This further allows the user to directly control operation of the elevator car, e.g. to drive the car to a landing, and/or to open the elevator car doors, by sending control signals to the safety controller once the computing device is authenticated.

It is important that only authorized personnel are able to make these changes, or cause these actions, since there could be serious safety implications if non-authorized personnel start interfering with operation of the elevator system in this manner. It is therefore important that secure authentication is required in order to permit these actions.

Successful authentication of the computing device grants the computing device maintenance access to the safety controller, where this maintenance access is such as to include permission to control or modify an operation of the safety controller. Other kinds of maintenance access to the safety controller (i.e., not including control or modification of operations of the safety controller) may be possible with lower security, e.g., with only single factor authentication or without any authentication. Examples of such operations which might be permitted after only single-factor authentication include updating of software in a node of the safety controller, and updating of the configuration setup of the safety controller.

It will be appreciated that where it is stated above that a device or component is “arranged to” carry out a particular step or function, the described step or function may likewise optionally form part of the described method. Similarly, the components of the elevator system described above may be arranged to carry out any of the method steps described above.

### DRAWING DESCRIPTION

Certain preferred examples of this disclosure will now be described, by way of example only, with reference to the accompanying drawings, in which:

FIG. 1 is a schematic view of an elevator system according to an example of the present disclosure;

FIG. 2 is a schematic diagram showing a safety system and associated components, according to an example of the present disclosure;

FIG. 3 is a schematic drawing illustrating the communication between a computing device and a safety controller via a gateway device; and

FIG. 4 is a flow diagram showing a method of authenticating a computing device to a safety controller, according to the present disclosure.

### DETAILED DESCRIPTION

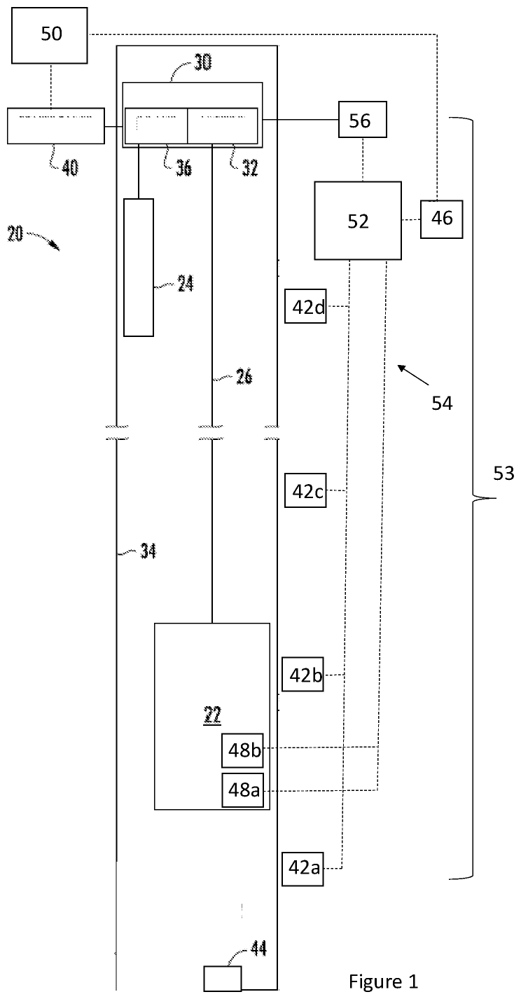

As shown in FIG. 1, an elevator system 20 comprises an elevator car 22 that runs in a hoistway 34 between various floors of a building. In this example the elevator car 22 is suspended in the hoistway 34 by a tension member 26 (e.g. one or more ropes or belts). The other end of the tension member 26 is connected to a counterweight 24. The elevator car 22 and the counterweight 24 are moving components in the elevator system 20. However, it will be appreciated that in other examples the elevator system may be ropeless.

During normal operation, the elevator car 22 travels up and down in the hoistway 34 to transport passengers and/or cargo between floors of the building. The elevator car 22 is driven by a drive system 30 comprising a drive motor 32 and a motor brake 36. The tension member 26 passes over a drive sheave (not shown) that is driven to rotate by the drive motor 32 and braked by the motor brake 36. Normal operation of the drive system 30 is controlled by an elevator controller 40.

The elevator system 20 also comprises an absolute position measurement system 50 configured to determine the absolute position and velocity of the elevator car 22 in the hoistway 34. In this example, the absolute position measurement system 50 is configured to output a measurement of the absolute position and velocity of the elevator car 22 to the elevator controller 40. The absolute position measurement system 50 is also connected to a safety controller 52 (described in more detail below). In other examples, the absolute position measurement system 50 may only have a connection to the safety controller 52 instead of its connection to the elevator controller 40 as shown. In any such examples, the absolute position measurement system 50 can include a coded tape (not shown) extending at least part of the way along the hoistway 34 and two sensors (not shown) mounted on the elevator car 22 and arranged to read the coded tape to determine the absolute position and velocity of the elevator car 22 in the hoistway 34.

The elevator system 20 also comprises a safety system 53, including a safety controller 52 connected to a safety bus 54. As mentioned above, the absolute position measurement system 50 may also (or alternatively) be connected to the safety controller 52 over the safety bus 54, and may also (or alternatively) supply the position and velocity information to the safety controller 52.

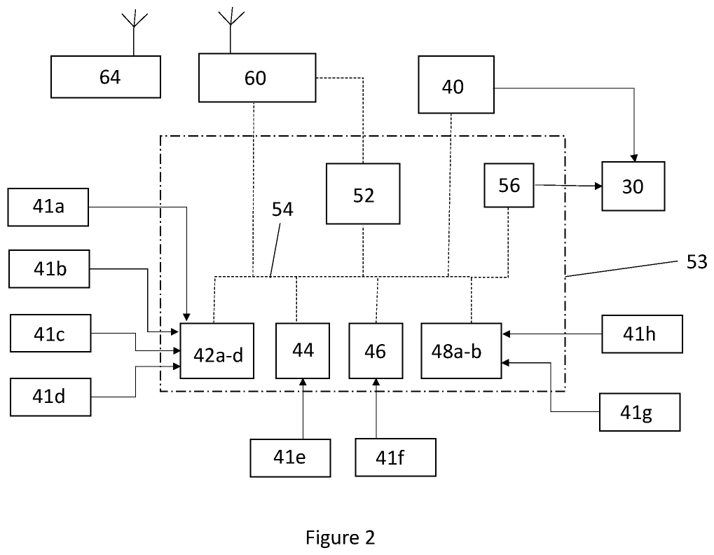

The safety controller 52 may be a node as defined in the relevant Programmable Electronic System in Safety Related Applications for Lifts (PESSRAL) standard(s). The safety controller 52 communicates over the safety bus 54 with a plurality of bus nodes 42a-d, 44, 46, 48a-b. The safety bus 54 may be a CAN bus, and is represented in FIGS. 1 and 2 with a dashed line.

The bus nodes 42a-d, 44, 46, 48a-b are each associated with one of a plurality of safety contacts located throughout the elevator system 20. In the particular example as shown, there are four landing door nodes 42a-d, each corresponding to a respective set of landing doors of the elevator system 20. There is a pit switch node 44, which is associated with a safety contact in the pit of the elevator system 20. This safety contact may be opened by a maintenance person when they are working in the pit. There is an overspeed node 46, associated with an overspeed switch or safety contact which detects an overspeed condition of the elevator car 22, and opens if an overspeed is detected. The overspeed node 46 is connected to the absolute position measurement system 50. There are also two nodes, 48a, 48b, associated with the safety contacts of the elevator car 22. In particular, there is an elevator door node 48a, connected to a door sensor, and an emergency stop node 48b.

The safety system 53 is shown in greater detail in FIG. 2, together with associated components. It can be seen that each of the nodes 42a-d, 44, 46, 48a-b is connected to at least one of the safety contacts 41a-41h, as described above. The safety system 53 also includes an actuator node 56, connected to the safety bus 54. If required, the actuator node 56 can interrupt the supply of power to the drive system 30 to execute an emergency stop, as described below. It will be understood that the actuator node 56 in the safety system 53 is configured to interrupt operation of the drive system 30 (e.g. upon detection of an unsafe condition) independently of the elevator controller 40 being configured to control the drive system 30 during normal operating conditions. Actuator node 56 simply allows or prevents movement of the elevator car 22, but cannot be used to drive the elevator car 22 to a floor. It is the elevator controller 40 which issues a run command to the drive system 30.

The safety bus 54 also connects the safety controller 52 to a wireless communications gateway device 60, by means of which the safety controller 52 can wirelessly connect with an external computing device 64, as described below.

The safety bus 54 is also connected to the elevator controller 40, such that the elevator controller 40 receives individual status information from the safety system 53, indicating the status of each of the safety contacts 41a-41g, i.e. whether each safety contact is open or closed. Thus, the safety controller 52 monitors and evaluates the individual status of each safety contact, but this information is also provided to the elevator controller 40 to facilitate maintenance work, e.g. by displaying the status of the individual safety contacts 41a-41g, or the overall safety chain, on devices in the elevator system 20.

Although shown separately, the safety controller 52 may be part of the elevator controller 40, and therefore the elevator controller 40 may be connected to the gateway device 60 (and able to connect via the gateway device 60 to the computing device 64), as described below. In examples where the safety controller 52 is part of the elevator controller 40 the authentication process described below may still only provide authentication for control of the safety controller 52 (but not to alter operation of the elevator controller 40), or alternatively it may authenticate the computing device 64 to also control or modify operations of the elevator controller 40 (e.g., to move the elevator car 22).

The safety controller 52 carries out a variety of functions, which help the elevator system 20 to be operated safely. This includes triggering an emergency stop of the elevator car 22, based on information obtained from the various nodes 42a-d, 44, 46, 48a-b connected to the safety bus 54. For instance, if a hoistway door is opened (as detected by nodes 42a-d), if a maintenance worker is present in the pit of the hoistway 34 (as detected by node 44) or, the elevator car 22 travels too quickly (as detected by overspeed node 46), an emergency stop may be executed, e.g. by interrupting the supply of power to the drive system 30 using the actuator node 56. The loss of power triggers the brake 36 to engage and stops the motor 32 (i.e. removes any drive torque applied to the drive sheave). This brings the elevator car 22 (and the counterweight 24) quickly to a halt.

Once the safety controller 52 has been triggered in this way, it is known for the elevator system 20 to be configured such that the safety system 53 cannot then be overridden, and therefore movement of the elevator car 22 restored, until a maintenance person attends the elevator system 20 in person, inspects the elevator system 20, and manually overrides the safety controller 52. In some cases, passengers are inside the elevator car 22 when the emergency stop is carried out, and will therefore become trapped if the elevator car 22 is stopped between landings. Override of the safety controller 52, in order to allow the elevator car 22 to be moved to a landing, is required in order to rescue such trapped passengers. This is one example of controlling or modifying an operation of the safety controller 52.

In order to control or modify an operation of the safety controller 52, a maintenance person must authenticate to the safety controller 52, to demonstrate that they are authorized personnel. This helps to keep the operation of the elevator system 20 secure and safe.

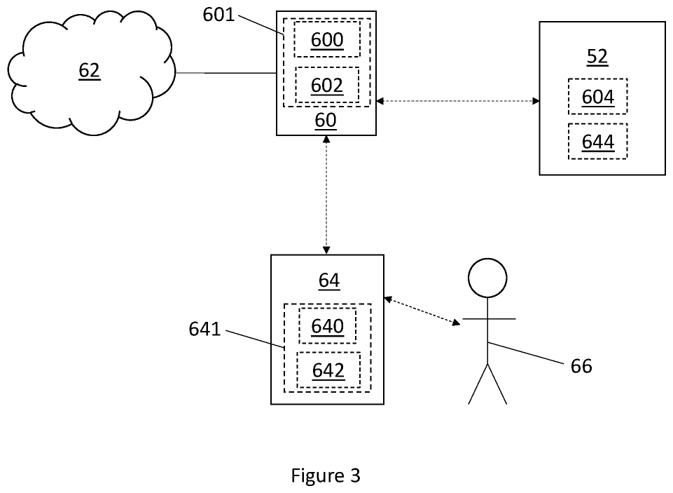

The components taking part in the authentication process are shown schematically in FIG. 3.

As described above, the elevator system 20 includes a safety controller 52, and a wireless communications gateway device 60 enabling connection to a computing device 64 which may be operated by a maintenance person 66. These may be connected together via a wired or wireless communications network. The gateway device 60 may be connected to the Internet 62. It may therefore connect to various devices (including the safety controller 52, and the computing device 64) via the Internet 62. It will be understood that the computing device 64 may be remote from the elevator system or may alternatively be present locally at or within the elevator system. Even in this case it may connect wirelessly to the gateway device 60, or may be in wired connection with the gateway device 60.

The gateway device 60 stores first authentication information 600, which in this example is a first certificate, and a first private key 602 in a memory 601. The first private key 602 may be stored on the device during manufacturing (e.g., in a secure facility) or the private key 602 may be created on the device itself (e.g., there is a secure chip on the device which can be commanded to create a private key including the matching public key).

A trusted certificate authority is used to generate the first authentication information 600 (i.e., the first certificate). To do so, firstly the gateway device 60 sends a request, containing the public key corresponding to the private key 602 used by the gateway device 60) and gateway credentials (optionally encrypted with the first private key 602), to a certificate authority. The certificate authority verifies the information in the request and “digitally signs” the certificate with a certificate authority private key (which the certificate authority guarantees cannot be hacked). This first authentication information 600 (i.e., first certificate) is then sent to the gateway device 60, where it is stored. Optionally the certificate authority public key, corresponding to the certificate authority private key that was used to digitally sign the certificate, is also sent to the gateway device 60. This process can take place via the Internet 62.

The first authentication information 600 is sent from the gateway device 60 to the safety controller 52, as described below. The safety controller 52 can then confirm the certificate authority's digital signature of the first authentication information 600 (i.e., the first certificate) using the certificate authority's public key. Then, since the first authentication information 600 contains the public key 604 corresponding to the private key 602 that the gateway device 60 uses to encrypt the gateway credentials, the safety controller 52 is able to decrypt the received gateway credentials using the public key 604 (i.e., corresponding to the private key 602 used by the gateway device 60). This effectively confirms a digital signature from the gateway device 60, since encryption by the gateway device 60 using the private key 602 has effectively signed the first authentication information 600.

Similarly, the computing device 64 stores second authentication information 640 (which in this example is a second certificate), generated in the same manner as described above using a second private key 642 stored on the computing device 64. This second authentication information 640 and the second private key 642 are stored in a memory 641 of the computing device 64. The safety controller 52 can then confirm the certificate authority's digital signature of the second authentication information 640 using the certificate authority's public key. Then, since the second authentication information 640 contains the public key 644 corresponding to the private key 642 that the computing device 64 uses to encrypt the gateway credentials, the safety controller 52 is able to decrypt the received second authentication information 640 using the second public key 644. This effectively confirms a digital signature from the computing device 64 (i.e., that it is possession of the second private key 642) , since encryption by the computing device 64 using the private key 642 has effectively signed the second authentication information 640. The validity of the decrypted second authentication information 640 (i.e., the second certificate) is then checked using the certificate authority's public key, e.g. it is checked whether the certificate is signed by a trusted certificate authority.

The public keys 604, 644 used by the safety controller 52 are provided in advance, i.e., when the gateway device 60 and computing device 64 are registered by an administrator as authorized devices. Alternatively, these public keys 604, 644 can be provided later, e.g. during a communication session.

The certificate authority (and therefore the certificate authority private and public keys) may be the same for both the first and second certificates 600, 640, or different certificate authorities could be used to generate each.

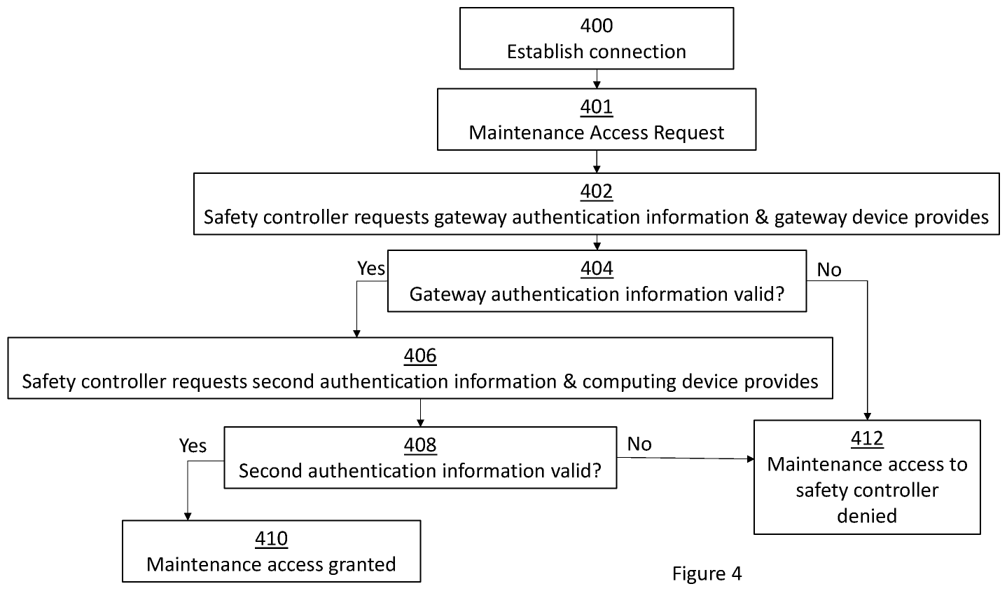

According to the present example, the authentication is two-factor, meaning that two pieces of information must be presented, and verified successfully, for authentication to take place. The authentication process is described below with reference to FIG. 4.

First, at stage 400, the computing device 64 establishes a connection with the gateway device 60. Then, using this connection, the computing device 64 issues a maintenance access request to the safety controller 52, via the gateway device 60. This is stage 401 shown in FIG. 4.

In response to receipt of this request, the safety controller 52 requests the gateway device 60 to provide its gateway authentication information (i.e., the first authentication information 600, which in this example is the first certificate). This is stage 402. The gateway device 60 provides the requested certificate in response to this request.

At stage 404, the safety controller 52 checks the validity of the first authentication information 600 as described above with reference to FIG. 3. If the first authentication information 600 is found to be invalid then the authentication process fails, as shown at stage 412, and the second authentication information is not requested.

Alternatively, if the certificate is found to be valid, then the safety controller 52 requests separate, second authentication information 640 (i.e., the second certificate) from the computing device 64. The computing device 64 sends the second authentication information 640 to the safety controller 52, via the gateway device 60. This is stage 406.

Then, at stage 408, the safety controller 52 checks the validity of the second authentication information 640 as described above with reference to FIG. 3.

If the second certificate 640 is found to be invalid then the authentication process fails, as shown at stage 412.

Alternatively, if the certificate is found to be valid then the safety controller 52 is authenticated. The process then moves to stage 410 at which the computing device 64 is granted maintenance access to the safety controller 52, in particular access which includes permissions to control and/or modify an operation of the safety controller 52.

It will be appreciated by those skilled in the art that the disclosure has been illustrated by describing one or more specific aspects thereof, but is not limited to these aspects; many variations and modifications are possible, within the scope of the accompanying claims.

What is claimed is:

1. An elevator system (20) comprising:
a gateway device (60);
a safety controller (52) arranged to monitor at least one safety condition of the elevator system (20),
wherein the gateway device (60) is configured to enable a computing device (64) to establish a connection with the gateway device (60), and
wherein the safety controller (52) is configured to:
receive first authentication information (600) from the gateway device (60), wherein the first authentication information (600) is gateway authentication information (600);
check whether the gateway authentication information (600) meets a first authentication condition;
if the gateway authentication information (600) meets the first authentication condition, receive from the computing device (64), via the gateway device (60), second authentication information (640);
check whether the second authentication information (640) meets a second authentication condition; and
if the second authentication information (640) meets the second authentication condition, authenticate the computing device (64), wherein the authenticated computing device (64) is granted maintenance access to the safety controller (52) including permission to control and/or modify an operation of the safety controller (52).

2. The elevator system (20) of claim 1, wherein the first authentication information (600) and/or the second authentication information (640) is generated by a certificate authority.

3. The elevator system of claim 2, wherein the safety controller (52) is arranged to confirm that the certificate authority has verified the first authentication information (600) and/or the second authentication information (640) by decrypting the information using a certificate authority public key.

4. The elevator system of claim 1, wherein the gateway device (60) comprises a memory (601), wherein the gateway device (60) is arranged to store the gateway authentication information (600) in the memory (601).

5. The elevator system (20) of claim 1, wherein the second authentication information (640) is computing device authentication information or maintenance person authentication information.

6. The elevator system (20) of claim 1, wherein the second authentication information (640) is computing device authentication information, wherein the computing device (64) comprises a memory (641), and wherein the computing device (64) is arranged to store the computing device authentication information (640) in the memory (641).

7. The elevator system (20) of claim 1, wherein the computing device (64) is a remote computing device.

8. The elevator system (20) of claim 1, wherein the computing device (64) is a mobile telephone or a mobile service tool.

9. The elevator system (20) of claim 1, wherein the gateway device (60) is connected to the Internet (62) and/or the Cloud.

10. The elevator system (20) of claim 1, wherein controlling and/or modifying an operation of the safety controller (52) includes overriding the safety controller (52).

11. A method of authenticating a computing device (64) to a safety controller (52) of an elevator system (20) for maintenance access to the safety controller (52), the method comprising:
the computing device (64) establishing a connection with a gateway device (60) of an elevator system (20);
the safety controller (52):
receiving from the gateway device (60) first authentication information (600), wherein the first authentication information (600) is gateway authentication information (600);
checking whether the gateway authentication information (600) meets a first authentication condition;
if the gateway authentication information (600) meets the first authentication condition, receiving from the computing device (64), via the gateway device (60), second authentication information (640);
checking whether the second authentication information (640) meets a second authentication condition; and
if the second authentication information (640) meets the second authentication condition, authenticating the computing device (64), wherein the authenticated computing device (64) is granted maintenance access to the safety controller (52) including permission to control and/or modify an operation of the safety controller (52).

12. The method of claim 11, further comprising the computing device (64) issuing to the gateway device (60) a maintenance access request, and, in response to receiving the maintenance access request from the computing device (64), the gateway device (60) issuing the maintenance access request to the safety controller (52), on behalf of the computing device (64).

13. The method of claim 12, further comprising, in response to receiving the maintenance access request, the safety controller (52) issuing a first authentication information request to the gateway device (60), and the gateway device (60) transmitting the first authentication information (600) to the safety controller (52) in response to receipt of the first authentication information request.

14. The method of claim 11, further comprising, if the gateway authentication information (600) meets the first authentication condition, the computing device (64) issuing to the gateway device (60) a second authentication information request, and the gateway device (60) passing the second authentication information request to the computing device (64).

15. The method of claim 14, further comprising the computing device (64) sending second authentication information (640) to the safety controller (52), via the gateway device (60), in response to receipt of the second authentication information request.
